(19) United States
(12) Patent Application Publication
(10) Pub. No.: US 2026/0270307 A1
(43) Pub. Date: Sep. 10, 2026

(54) QUALITY OF SERVICE PROCESSING

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 19/670,751

(22) Filed: May 7, 2026

Related U.S. Application Data
(63) Continuation of application No. PCT/CN2024/109644, filed on Aug. 2, 2024.

(30) Foreign Application Priority Data
Dec. 22, 2023 (CN) 202311793216.3

(51) Int. Cl. H04L 65/80; H04L 65/1108; H04L 65/65; H04L 69/164

(52) U.S. Cl. CPC H04L 65/80; H04L 65/1108; H04L 65/65; H04L 69/164

(57) ABSTRACT

In a quality of service (QoS) processing method, QoS requirement information of a multimedia service is generated, data packets of the multimedia service being categorized into a plurality of media types and mapped to a QoS flow, and the QoS requirement information indicating respective QoS settings for the plurality of media types. In the method, categorization information indicating an association relationship between each of the data packets of the multimedia service and a corresponding one of the plurality of media types is transmitted to a core network element in a communication system. In the method, the QoS requirement information is transmitted to the core network element. The core network element is configured to generate QoS policy information indicating QoS policies for transmission of the data packets of the multimedia service based on the categorization information and the QoS requirement information. Apparatus and non-transitory computer-readable storage medium counterparts are also contemplated.

### RELATED APPLICATIONS

The present application is a continuation of International Application No. PCT/CN2024/109644, filed on August 2, 2024, which claims priority to Chinese Patent Application No. 202311793216.3, filed on December 22, 2023, and entitled "QUALITY OF SERVICE PROCESSING METHOD AND APPARATUS, COMPUTER-READABLE MEDIUM, AND ELECTRONIC DEVICE." The entire disclosures of the prior applications are hereby incorporated by reference.

### FIELD OF THE TECHNOLOGY

This disclosure relates to the field of computer and communication technologies, including a quality of service processing method and apparatus, a computer-readable medium, and an electronic device.

### BACKGROUND OF THE DISCLOSURE

In a 5th-generation (5G) mobile communication technology and subsequent evolved systems (for example, 5G-A and 6G), high-bandwidth interactive services are an important service type, for example, cloud gaming, virtual reality (VR), augmented reality (AR), mixed reality (MR), extended reality (XR), cinematic reality (CR), or XR and media services (XRM).

The high-bandwidth interactive services have a high requirement for transmission timeliness, as well as a great increase in data volumes generated by application layers as indicators such as a resolution and a frame rate increase. Therefore, data packet content generated by the application layers of such services is usually transmitted by using a series of data packets with a correlation. In some examples, the series of data packets may correspond to a protocol data unit (PDU) set. For a transmission process of the series of data packets, how to effectively perform transmission control to deal with a challenge of the high-bandwidth interactive services to wireless network transmission is to be resolved.

### SUMMARY

Embodiments of this disclosure provide a quality of service (QoS) processing method and apparatus, a computer-readable medium, and an electronic device, which can implement finer-grained QoS processing on service flow data packets (e.g., data packets of an application layer service, such as a multimedia service) of different media types, to facilitate improvement of a resource utilization rate and user experience.

According to a first aspect, this disclosure provides a QoS processing method. In the method, QoS requirement information of a multimedia service is generated by processing circuitry, data packets of the multimedia service being categorized into a plurality of media types and mapped to a QoS flow, and the QoS requirement information indicating respective QoS settings for the plurality of media types. In the method, categorization information indicating an association relationship between each of the data packets of the multimedia service and a corresponding one of the plurality of media types is transmitted to a core network element in a communication system. In the method, the QoS requirement information is transmitted to the core network element. The core network element is configured to generate QoS policy information indicating QoS policies for transmission of the data packets of the multimedia service based on the categorization information and the QoS requirement information.

According to a second aspect, this disclosure provides a QoS processing method. In the method, QoS requirement information of a multimedia service is obtained, data packets of the multimedia service being categorized into a plurality of media types and mapped to a QoS flow, and the QoS requirement information indicating respective QoS settings for the plurality of media types. In the method, categorization information indicating an association relationship between each of the data packet of the multimedia service and a corresponding one of the plurality of media types is obtained. In the method, based on the categorization information and the QoS requirement information, QoS policy information indicating QoS policies for transmission of the data packets of the multimedia service in a communication system is generated by processing circuitry. In the method, the QoS policy information is transmitted to a network element in the communication system, the network element is configured to configure the communication system based on the QoS policy information.

According to a third aspect, this disclosure provides a QoS processing method. In the method, QoS policy information indicating QoS policies for transmission of data packets of a multimedia service is received, the data packets of the multimedia service being categorized into a plurality of media types and mapped to a QoS flow, the QoS policy information being generated based on categorization information and QoS requirement information of the multimedia service, and the categorization information indicating an association relationship between each of the data packet of the multimedia service and a corresponding one of the plurality of media types and the QoS requirement information indicating respective QoS settings for the plurality of media types. In the method, QoS processing-related information is generated by processing circuitry based on the QoS policy information. In the method, the QoS processing-related information is transmitted to a network element in a communication system configured to process transmission of the data packets in communication system based on the QoS processing-related information.

According to a fourth aspect, this disclosure provides a QoS processing apparatus that includes processing circuitry configured to generate QoS requirement information of a multimedia service, data packets of the multimedia service being categorized into a plurality of media types and mapped to a QoS flow, and the QoS requirement information indicating respective QoS settings for the plurality of media types. The processing circuitry is configured to transmit, to a core network element in a communication system, categorization information indicating an association relationship between each of the data packets of the multimedia service and a corresponding one of the plurality of media types. The processing circuitry is configured to transmit, to the core network element, the QoS requirement information. The core network element is configured to generate QoS policy information indicating QoS policies for transmission of the data packets of the multimedia service based on the categorization information and the QoS requirement information.

According to a fifth aspect, this disclosure provides a QoS processing apparatus that includes processing circuitry configured to obtain QoS requirement information of a multimedia service, data packets of the multimedia service being categorized into a plurality of media types and mapped to a QoS flow, and the QoS requirement information indicating respective QoS settings for the plurality of media types. The processing circuitry is configured to obtain categorization information indicating an association relationship between each of the data packet of the multimedia service and a corresponding one of the plurality of media types. The processing circuitry is configured to generate, based on the categorization information and the QoS requirement information, QoS policy information indicating QoS policies for transmission of the data packets of the multimedia service in a communication system. The processing circuitry is configured to transmit the QoS policy information to a network element in the communication system, the network element is configured to configure the communication system based on the QoS policy information.

According to a sixth aspect, this disclosure provides a QoS processing apparatus that includes processing circuitry configured to receive QoS policy information indicating QoS policies for transmission of data packets of a multimedia service, the data packets of the multimedia service being categorized into a plurality of media types and mapped to a QoS flow, the QoS policy information being generated based on categorization information and QoS requirement information of the multimedia service, and the categorization information indicating an association relationship between each of the data packet of the multimedia service and a corresponding one of the plurality of media types and the QoS requirement information indicating respective QoS settings for the plurality of media types. The processing circuitry is configured to generate QoS processing-related information based on the QoS policy information. The processing circuitry is configured to transmit the QoS processing-related information to a network element in a communication system configured to process transmission of the data packets in communication system based on the QoS processing-related information.

According to a seventh aspect, this disclosure provides a non-transitory computer-readable storage medium storing instructions, which when executed by a processor, cause the processor to perform a QoS processing method. In the method, QoS requirement information of a multimedia service is generated, data packets of the multimedia service being categorized into a plurality of media types and mapped to a QoS flow, and the QoS requirement information indicating respective QoS settings for the plurality of media types. In the method, categorization information indicating an association relationship between each of the data packets of the multimedia service and a corresponding one of the plurality of media types is transmitted to a core network element in a communication system. In the method, the QoS requirement information is transmitted to the core network element. The core network element is configured to generate QoS policy information indicating QoS policies for transmission of the data packets of the multimedia service based on the categorization information and the QoS requirement information.

According to an eighth aspect, this disclosure provides a non-transitory computer-readable storage medium storing instructions, which when executed by a processor, cause the processor to perform a QoS processing method. In the method, QoS requirement information of a multimedia service is obtained, data packets of the multimedia service being categorized into a plurality of media types and mapped to a QoS flow, and the QoS requirement information indicating respective QoS settings for the plurality of media types. In the method, categorization information indicating an association relationship between each of the data packet of the multimedia service and a corresponding one of the plurality of media types is obtained. In the method, based on the categorization information and the QoS requirement information, QoS policy information indicating QoS policies for transmission of the data packets of the multimedia service in a communication system is generated. In the method, the QoS policy information is transmitted to a network element in the communication system, the network element is configured to configure the communication system based on the QoS policy information.

According to a ninth aspect, this disclosure provides a non-transitory computer-readable storage medium storing instructions, which when executed by a processor, cause the processor to perform a QoS processing method. In the method, QoS policy information indicating QoS policies for transmission of data packets of a multimedia service is received, the data packets of the multimedia service being categorized into a plurality of media types and mapped to a QoS flow, the QoS policy information being generated based on categorization information and QoS requirement information of the multimedia service, and the categorization information indicating an association relationship between each of the data packet of the multimedia service and a corresponding one of the plurality of media types and the QoS requirement information indicating respective QoS settings for the plurality of media types. In the method, QoS processing-related information is generated based on the QoS policy information. In the method, the QoS processing-related information is transmitted to a network element in a communication system configured to process transmission of the data packets in communication system based on the QoS processing-related information

According to a tenth aspect, this disclosure provides a QoS processing method, including: generating QoS requirement information respectively corresponding to service flow data packets of a plurality of media types mapped to the same QoS flow; and providing, to a core network element, the QoS requirement information respectively corresponding to the service flow data packets of the plurality of media types, to cause the core network element to generate QoS policy information corresponding to the plurality of media types based on the QoS requirement information.

According to an eleventh aspect, this disclosure provides a QoS processing method, including: obtaining QoS requirement information respectively corresponding to service flow data packets of a plurality of media types mapped to the same QoS flow; generating, based on the QoS requirement information respectively corresponding to the service flow data packets of the plurality of media types, QoS policy information configured for processing the service flow data packets of the plurality of media types, and transmitting the QoS policy information to a session management function, to cause the session management function to configure QoS processing-related information for a service flow data packet processing device based on the QoS policy information.

According to a twelfth aspect, this disclosure provides a QoS processing method, including: receiving QoS policy information that is sent by a policy control function and that is configured for processing service flow data packets of a plurality of media types, the QoS policy information being generated based on QoS requirement information respectively corresponding to the service flow data packets of the plurality of media types mapped to the same QoS flow; generating QoS processing-related information respectively corresponding to service flow data packet processing devices based on the QoS policy information; and configuring the QoS processing-related information for the service flow data packet processing devices.

According to a thirteenth aspect, this disclosure provides a QoS processing apparatus, including: a generation unit, configured to generate QoS requirement information respectively corresponding to service flow data packets of a plurality of media types mapped to the same QoS flow; and a transmission unit, configured to provide, to a core network element, the QoS requirement information respectively corresponding to the service flow data packets of the plurality of media types, to cause the core network element to generate QoS policy information corresponding to the plurality of media types based on the QoS requirement information.

According to a fourteenth aspect, this disclosure provides a QoS processing apparatus, including: an obtaining unit, configured to obtain QoS requirement information respectively corresponding to service flow data packets of a plurality of media types mapped to the same QoS flow; a generation unit, configured to generate, based on the QoS requirement information respectively corresponding to the service flow data packets of the plurality of media types, QoS policy information configured for processing the service flow data packets of the plurality of media types, and a transmission unit, configured to transmit the QoS policy information to a session management function, to cause the session management function to configure QoS processing-related information for a service flow data packet processing device based on the QoS policy information.

According to a fifteenth aspect, this disclosure provides a QoS processing apparatus, including: a receiving unit, configured to receive QoS policy information that is transmitted by a policy control function and that is configured for processing service flow data packets of a plurality of media types, the QoS policy information being generated based on QoS requirement information respectively corresponding to the service flow data packets of the plurality of media types mapped to the same QoS flow; a generation unit, configured to generate QoS processing-related information respectively corresponding to service flow data packet processing devices based on the QoS policy information; and a transmission unit, configured to configure the QoS processing-related information for the service flow data packet processing devices.

According to a sixteenth aspect, this disclosure provides a computer-readable medium, having a computer program stored therein, the computer program, when executed by a processor, implementing the QoS processing method according to the foregoing embodiments.

According to a seventeenth aspect, this disclosure provides an electronic device, including: processing circuitry such as one or more processors; and a memory, including a non-transitory computer-readable storage medium configured to store one or more computer programs. The one or more computer programs, when executed by the one or more processors, cause the electronic device to implement the QoS processing method according to the foregoing embodiments.

According to an eighteenth aspect, this disclosure provides a computer program product, the computer program product including a computer program, and the computer program being stored in a non-transitory computer-readable storage medium. Processing circuitry (such as a processor) of an electronic device reads the computer program from the non-transitory computer-readable storage medium and executes the computer program, causing the electronic device to perform the QoS processing method according to the foregoing embodiments.

In technical solutions provided in some embodiments of this disclosure, QoS requirement information respectively corresponding to service flow data packets of a plurality of media types mapped to the same QoS flow is generated and provided to a core network element, to cause the core network element to generate QoS policy information corresponding to the plurality of media types based on the QoS requirement information. In this way, when the service flow data packets of the plurality of media types share the same QoS flow, finer-grained (that is, a granularity finer than that of the QoS flow) QoS processing can be implemented on service flow data packets of different media types, to facilitate improvement of a resource utilization rate for processing the service flow data packets and user experience, thereby better dealing with a challenge of a high-bandwidth interactive service to wireless network transmission.

The foregoing general descriptions and the following detailed descriptions provide non-limiting examples, and are not intended to limit this disclosure.

### BRIEF DESCRIPTION OF THE DRAWINGS

FIG. 1 is a schematic diagram of a system architecture to which technical solutions in embodiments of this disclosure may be applied.

FIG. 2 is a schematic diagram of a transmission process of a multimedia data packet according to an embodiment of this disclosure.

FIG. 3 is a flowchart of a QoS processing method according to an embodiment of this disclosure.

FIG. 4 is a flowchart of a QoS processing method according to an embodiment of this disclosure.

FIG. 5 is a flowchart of a QoS processing method according to an embodiment of this disclosure.

FIG. 6 is a schematic diagram of an architecture of key network elements in a 5G network.

FIG. 7 is a flowchart of a QoS processing method according to an embodiment of this disclosure.

FIG. 8 is a flowchart of a QoS processing method according to an embodiment of this disclosure.

FIG. 9 is a block diagram of a QoS processing apparatus according to an embodiment of this disclosure.

FIG. 10 is a block diagram of a QoS processing apparatus according to an embodiment of this disclosure.

FIG. 11 is a block diagram of a QoS processing apparatus according to an embodiment of this disclosure.

FIG. 12 is a schematic structural diagram of a computer system adapted to implement an electronic device according to an embodiment of this disclosure.

### DETAILED DESCRIPTION

Examples are described below with reference to the accompanying drawings. However, the examples may be implemented in various forms, and are not to be understood as being limited to these examples.

Descriptions of terms in this disclosure are provided as examples and are not intended to limit the scope of the disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In addition, the features, structures or characteristics described in this disclosure may be combined in one or more embodiments in any appropriate manner. A person skilled in the art is to be aware that technical solutions of this disclosure may be implemented without using all detailed features in one or more embodiments, one or more details may be omitted, or other methods, elements, apparatuses, operations, or the like may be used.

In one or more embodiments of this disclosure, the term "module" or "unit" refers to a computer program having a predetermined function or a part of a computer program, and works together with other relevant parts to achieve a predetermined objective, and may be completely or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or the unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Block diagrams shown in the accompanying drawings are functional entities and do not necessarily correspond to physically independent entities. These functional entities may be implemented in a software form, or in one or more hardware modules or integrated circuits, or in different networks and/or processor apparatuses and/or microcontroller apparatuses.

Flowcharts shown in the accompanying drawings are non-limiting examples, do not necessarily include all content and operations/steps, and are not necessarily performed in the described sequences. For example, some operations/steps may be further divided, while some operations/steps may be combined or partially combined. Therefore, an actual performing sequence may change based on an actual situation.

"A plurality of" mentioned in this disclosure may refer to two or more. "And/or" describes an association relationship between associated objects and represents that three relationships may exist. For example, A and/or B may represent the following three cases: only A exists, both A and B exist, and only B exists. The character "/" generally indicates an "or" relationship between the associated objects.

With the development of 5G and subsequent evolved systems (for example, 5G-A and 6G), many multimedia services that require a great data volume and a short delay are applied. For example, an interactive service such as a cloud gaming service, VR, AR, MR, XR, and CR.

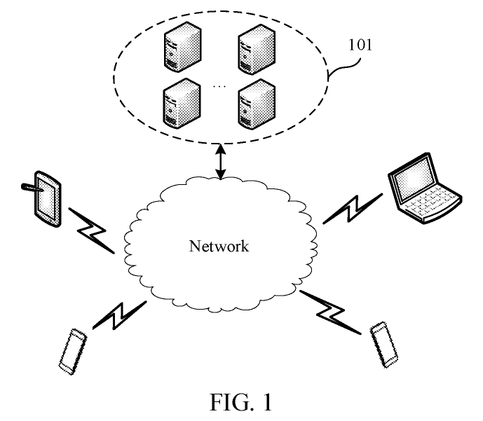

For example, in a cloud gaming scenario shown in FIG. 1, a cloud server 101 is configured to run cloud gaming. The cloud server 101 may render a game picture, encode an audio signal and a rendered image, and finally transmit encoded data obtained through encoding to game clients through a network. A game client may be a user equipment (UE) having a basic streaming media playing capability, a human-computer interaction capability, a communication capability, and the like, for example, a smartphone, a tablet computer, a laptop computer, a desktop computer, a smart television, smart home, a vehicle terminal, or an aircraft. Alternatively, the game client may be an application running in a terminal device. In some examples, the game client may decode the encoded data transmitted by the cloud server 101, to obtain an analog audio and video signal, and play the analog audio and video signal.

FIG. 1 is an example for representing a system architecture of a cloud gaming system, and does not limit an architecture of the cloud gaming system. For example, in another embodiment, the cloud gaming system may further include a background server for scheduling, and the like. In addition, the cloud server 101 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and big data and an artificial intelligence platform. The game client and the cloud server 101 may be directly or indirectly connected in a wired or wireless communication manner. This is not limited in this disclosure.

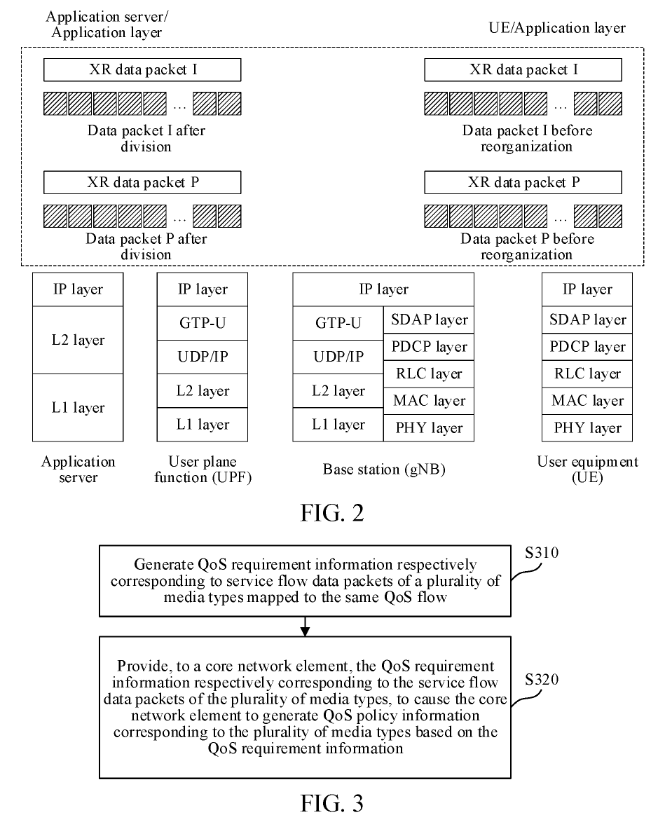

In the foregoing various multimedia-based interactive service application scenarios, because the multimedia data packet is huge, the multimedia data packet needs to be divided into a plurality of data packets for transmission. In at least one aspect, as shown in FIG. 2, for example, in a 5G system, a user plane may include an application server, a user plane function (UPF), a base station (next generation nodeB, gNB), and a UE. In some typical service scenarios, the multimedia data packet may be transmitted in a downlink direction, for example, from the application server (AS) to the UPF, and then sent to the UE via the gNB. During transmission, the multimedia data packet (for example, an XR data packet in FIG. 2) is divided on an application layer of the application server. After data packets obtained through division are used as IP packets from the application server to the UPF, the 5G system transmits sub-data packets to a UE end by using a PDU session. The sub-data packets are delivered upward layer by layer from a protocol stack of the UE end and reorganized to restore the multimedia data packet.

In the system shown in FIG. 2, an L1 layer is a physical layer, and is configured to process data transmission, such that original data can be transmitted on various physical media. An L2 layer is a data link layer, and the data link layer provides a service for a network layer based on a service provided by the physical layer. An Internet protocol (IP) layer is the network layer, configured to implement data transmission between two end systems. A UDP is a user datagram protocol. A GTP-U is a general packet radio service (GPRS) tunneling protocol-user plane. PHY is short for physical, and is a PHY layer. MAC is media access control. RLC is a radio link control protocol. A PDCP is a packet data convergence protocol. An SDAP is a service data adaptation protocol.

As described above, for the multimedia service (for example, an XRM service), it is common to divide a frame of multimedia data packet into a plurality of data packets for transmission. A data packet formed by a single multimedia service frame or a group of packets (GoP) may also have a large byte volume, and needs to be carried by a series of IP data packets. There is a correlation between the IP data packets, and processing the packets based on the correlation can effectively save a wireless network bandwidth.

For example, assuming that transmission is performed by using a plurality of IP data packets, the plurality of IP data packets may form a PDU set. If some data packets in the PDU set are lost, an entire frame, GoP, or other video content cannot be decoded. In this case, remaining data in the PDU set is also meaningless to a decoder. However, if application layer forward error correction (FEC) or another mechanism is introduced, and the media application layer has a certain packet loss recovery capability or has resilience to packet loss, after some packets are lost, remaining data in the PDU set can still be decoded. In this case, the remaining data in the PDU set is still meaningful for decoding at a receiving end.

In addition, in terms of a QoS processing mechanism, if different PDU sets are differentiated for correlation of application layer data packets, a PDU set that has a high rate but can tolerate a certain packet loss rate or a delay excess rate can continue to be processed. In other words, a processing manner of the multimedia service can be more flexible. In addition, a QoS flow mapping manner used by the 5G System (5GS) may be mapping different PDU sets to different QoS flows, or may be mapping different PDU sets to the same QoS flow. However, no matter which mapping manner is, a QoS processing granularity that can be provided by the 5GS may be a QoS flow. In this case, if an application layer service flow includes a plurality of service flows having a QoS requirement, and the plurality of service flows share the same QoS flow, the current 5GS may not provide different QoS supports for the plurality of service flows, which is insufficient for supporting a multi-modality multimedia service flow.

Based on the foregoing problem, technical solutions in embodiments of this disclosure provide a new QoS processing solution, so that when service flow data packets of a plurality of media types share the same QoS flow, finer-grained (that is, a granularity finer than that of the QoS flow) QoS processing can be implemented on service flow data packets of different media types, to facilitate improvement of a resource utilization rate for processing the service flow data packets and user experience, thereby better dealing with a challenge of a high-bandwidth interactive service to wireless network transmission.

Implementation details of the technical solutions in one or more embodiments of this disclosure are described in detail below.

FIG. 3 is a flowchart of a QoS processing method according to an embodiment of this disclosure. The QoS processing method may be performed by an application function (AF), or may be performed by another network element. As shown in FIG. 3, the QoS processing method includes at least S310 and S320, which are described in detail below.

S310: Generate QoS requirement information respectively corresponding to service flow data packets of a plurality of media types mapped to the same QoS flow. For example, QoS requirement information of a multimedia service is generated by processing circuitry (e.g., processing circuitry of an AF), data packets of the multimedia service being categorized into a plurality of media types and mapped to a QoS flow, and the QoS requirement information indicating respective QoS settings for the plurality of media types.

In some embodiments, the media types may include audio, video, and haptic or another media type. Service flow data packets of different media types may have different QoS requirement information, or may have the same QoS requirement information.

In some embodiments, the service flow data packets of the plurality of media types may be included in a multimedia service. For example, a cloud gaming service may include a service flow data packet of an audio type, a service flow data packet of a video type, and a service flow data packet of a haptic or another type. The service flow data packets of the plurality of media types are associated with the same multimedia service, and therefore may be mapped to the same QoS flow during transmission. However, the service flow data packets of the plurality of media types may have different QoS requirement information. Therefore, finer-grained (that is, a granularity finer than that of the QoS flow) QoS processing may be provided in this disclosure.

In some embodiments, the service flow data packets of the plurality of media types may be included in a plurality of different multimedia services. For example, a cloud gaming service and a VR service are integrated to form a cloud gaming service having a virtual reality feeling. Therefore, the service flow data packets of the plurality of media types are associated, and therefore may be mapped to the same QoS flow during transmission. However, the service flow data packets of the plurality of media types may have different QoS requirement information. Therefore, finer-grained QoS processing may be provided in this disclosure.

In some embodiments, the service flow data packets of the plurality of media types mapped to the same QoS flow may not be associated. In at least one aspect, due to a limited quantity of QoS flows included in a PDU session, when more QoS flows have been included in a PDU session, if no more QoS flow can be added to carry more service flow data packets, the service flow data packets of the plurality of media types may be mapped to one QoS flow. That is, the service flow data packets of the plurality of media types are carried by using one QoS flow. However, the service flow data packets of different media types may have different QoS requirement information. Therefore, finer-grained QoS processing may be provided in this disclosure.

In this disclosure, in addition to the cloud gaming service and the VR service, the multimedia service may alternatively be an AR service, an MR service, an XR service, an XRM service, a CR service, or the like.

In some embodiments, the service flow data packets may be transmitted by using a service data packet set (e.g., a PDU set). For example, a data packet formed by a single service frame or a GoP of a media type may have a large byte volume, and needs to be divided into a series of data packets for carrying. In addition, there is a correlation between the data packets. Therefore, the data packets having the correlation may be referred to as a PDU set, and are transmitted by using the PDU set. For the service flow data packets transmitted by using the PDU set, a QoS parameter in the corresponding QoS requirement information includes at least one of the following parameters: a PDU set delay budget (PSDB), a PDU set error rate (PSER), a maximum data burst volume (MDBV), or a packet delay variation (PDV).

In some examples, the data packets of the multimedia service are transmitted over a PDU set, and the QoS requirement information includes at least one of a PDU set delay budget, a PDU set error rate, a maximum data burst volume, or a data packet delay variation.

In some embodiments, the service flow data packets may be transmitted without using the PDU set, but by using a per-packet form. In this case, a QoS parameter in corresponding QoS requirement information includes at least one of the following parameters: a packet delay budget (PDB), a data packet loss rate (e.g., Packet Error Rate, PER), a maximum data burst volume, or the like.

In this disclosure, the service flow data packets of the plurality of media types may be all transmitted by using the PDU set, or may be all transmitted by using the per-packet form. Alternatively, service flow data packets of some media types may be transmitted by using the PDU set, and service flow data packets of the other media types may be transmitted by using the per-packet form.

S320: Provide, to a core network element, the QoS requirement information respectively corresponding to the service flow data packets of the plurality of media types, to cause the core network element to generate QoS policy information corresponding to the plurality of media types based on the QoS requirement information.

In some examples, categorization information is transmitted to a core network element (e.g., a PCF) in a communication system, the categorization information indicating an association relationship between each of the data packets of the multimedia service and a corresponding one of the plurality of media types. In some examples, the QoS requirement information is transmitted to the core network element. In some examples, the core network element is configured to generate QoS policy information indicating QoS policies for transmission of the data packets of the multimedia service based on the categorization information and the QoS requirement information.

In some embodiments, if the service flow data packets of the plurality of media types are mapped to the same QoS flow for processing, corresponding QoS processing may be performed on the service flow data packets during transmission based on QoS requirements of the service flow data packets of different media types. In this case, a device, for example, a UPF, a base station, or a UE, that monitors QoS of the service flow data packets may identify the service flow data packets of different media types, and perform corresponding QoS processing based on the service flow data packets of different media types.

In some embodiments, the service flow data packets of different media types may be identified and differentiated based on characteristics of the media types. For example, the audio type and the video type may be identified and differentiated by detecting whether image frame data is included. In some embodiments, various devices (for example, the UE, the base station, and the UPF) in a network may negotiate the categorization information of different media types (e.g., a differentiation manner between the data packets of different media types). For example, identification information configured for indicating a media type may be added to a protocol part or a payload part of a service flow data packet, and the media type is determined by identifying the identification information. The negotiation may be completed before the PDU session is established, or may be configured in these devices by default. In this way, during establishment of the QoS flow, the categorization information of different media types does not need to be transmitted between these devices.

In some embodiments, the categorization information of different media types may alternatively be transmitted to the core network element by a network element device like the AF or an AS. For example, when the QoS requirement information respectively corresponding to the service flow data packets of the plurality of media types mapped to the same QoS flow is transmitted to the core network element, the categorization information of the plurality of media types is transmitted to the core network element together. Alternatively, before or after the QoS requirement information respectively corresponding to the service flow data packets of the plurality of media types is transmitted to the core network element, the categorization information of the plurality of media types is transmitted to the core network element, so that the core network element (for example, a policy control function or a session management function) may consider the categorization information when generating a QoS-related policy or rule. This helps a service flow data packet processing device (for example, the UE, the base station, or the UPF) detect and differentiate between the service flow data packets of different media types based on the QoS-related policy or rule.

In some embodiments, after the QoS requirement information respectively corresponding to the service flow data packets of the plurality of media types is provided to the core network element, the core network element may generate, based on the QoS requirement information, QoS policy information corresponding to processing on the service flow data packets of the plurality of media types mapped to the same QoS flow. Certainly, the core network element may further determine whether to map the service flow data packets of the plurality of media types to the same QoS flow for processing; and may generate the corresponding QoS policy information if determining to map the service flow data packets of the plurality of media types to the same QoS flow for processing; or may generate QoS policy information corresponding to different QoS flows if determining to not map the service flow data packets of the plurality of media types to the same QoS flow for processing (for example, the service flow data packets of different media types are mapped to the different QoS flows for processing).

In some embodiments, the categorization information of different media types is configured for differentiating between the service flow data packets of different media types, and may be configured for identifying service flow data packets of various media types.

In some embodiments, the service flow data packets of the plurality of media types may be encapsulated in different media encapsulation manners. Therefore, when the categorization information of the plurality of media types is provided to the core network element, the media encapsulation manners respectively corresponding to the service flow data packets of the plurality of media types may be provided to the core network element. In some examples, the data packets of the multimedia service are encapsulated based on one of a plurality of candidate media encapsulation formats, and the categorization information indicates the association relationship based on one or more of the plurality of candidate media encapsulation formats.

In some embodiments, the service flow data packets may be encapsulated by using a quick user datagram protocol Internet connections (QUIC) protocol. In this case, the service flow data packets of different media types use different QUIC connection identifiers, or use different QUIC stream identifiers, or use different QUIC connection identifiers and different QUIC stream identifiers. For example, the data packets of the multimedia service are encapsulated based on a QUIC protocol, and the categorization information indicates that different media types are identifiable based on different QUIC connection identifiers or different QUIC stream identifiers of the data packets.

In some embodiments, the service flow data packets may be encapsulated by using a real-time transport protocol (RTP). In this case, the service flow data packets of different media types are differentiated by using different payload types. Different payload types (PT) are configured for indicating media types, for example, the audio type and the video type, included in a RTP packet. In some embodiments, a dynamic PT value may alternatively be configured for indicating different media types. For example, the data packets of the multimedia service are encapsulated based on an RTP, and the categorization information indicates that different media types are identifiable based on different payload type identifiers of the data packets.

In some embodiments, the service flow data packets may be encapsulated by using a web real-time communication (WebRTC) protocol. In this case, differentiated encapsulation may be performed on the service flow data packets of different media types by using a protocol stack of the WebRTC protocol. For example, the data packets of the multimedia service are encapsulated based on a protocol stack of a web real-time communication (WebRTC) protocol, and the categorization information indicates that different media types are encapsulated based on different WebRTC encapsulation approaches.

In some embodiments, an RTC peer connection (RTCpeerconnection) interface in the protocol stack of WebRTC provides a function of establishing and maintaining an end-to-end connection, and processes a change of a connection status and transmission of media data by using an RTC peer connection event. Therefore, different transmission options, for example, a transmission protocol and a transport layer port, may be set in an RTC peer connection, to differentiate between data transmission of different media types. For another example, the RTC peer connection (RTCDataChannel) interface in the protocol stack of WebRTC provides a function of end-to-end transmission of any binary data. Data of any type, including text, an image, a file, and the like, may be transmitted and received by using the RTC peer connection. Therefore, different data type identifiers may be set for data packets of different media types, to differentiate between the service flow data packets of different media types.

In some embodiments, the service flow data packets may be encapsulated by using WebTransport. In this case, differentiated encapsulation may be performed on the service flow data packets of different media types by using a protocol stack of WebTransport. For example, the data packets of the multimedia service are encapsulated based on a WebTransport, and the categorization information indicates that different media types are encapsulated based on different WebTransport encapsulation approaches.

In some embodiments, WebTransport supports a plurality of transport layer protocols, such as a transmission control protocol (TCP), and a user datagram protocol (UDP). Therefore, different transport layer protocols may be specified in signaling, to differentiate between data of different media types in the protocol stack of WebTransport. For example, haptic data may be transmitted by using the TCP, and audio and video data may be transmitted by using the UDP.

For another example, in the protocol stack of WebTransport, the data of different media types may be differentiated by allocating different port numbers or addresses to the data of different media types. For example, the haptic data may be transmitted by using a port number 10000, and the audio and video data may be transmitted by using a port number 20000.

For another example, the protocol stack of WebTransport supports a plurality of load types, and each load type corresponds to a media format or encoding manner. Different load types are specified in the signaling, so that the data of different media types may be differentiated in the protocol stack of WebTransport. For example, the haptic data may be transmitted by using a load type 1, and the audio and video data may be transmitted by using a load type 2.

For another example, WebTransport supports creation of a plurality of data channels, and each channel may be configured to transmit data of a different media type. Different data channels are specified in the signaling, so that the data of different media types may be differentiated in the protocol stack of WebTransport. For example, the haptic data may be transmitted by using a channel 1, and the audio and video data may be transmitted by using a channel 2.

In some embodiments, the service flow data packets of different media types may be encapsulated by using the same protocol, or may be encapsulated by using different protocols. If the service flow data packets of different media types are encapsulated by using different protocols, the protocol and the encapsulation manner described in the foregoing embodiments may be used for encapsulation, or another protocol may be used for encapsulation, where the service flow data packets of different media types can be differentiated in the encapsulation manner.

In some embodiments, when the QoS requirement information respectively corresponding to the service flow data packets of the plurality of media types is provided to the core network element, the QoS requirement information respectively corresponding to the service flow data packets of the plurality of media types may be directly transmitted to the policy control function. Alternatively, the QoS requirement information respectively corresponding to the service flow data packets of the plurality of media types may be transmitted to a network exposure function, and then the forwarded by the network exposure function to the policy control function. Alternatively, the QoS requirement information respectively corresponding to the service flow data packets of the plurality of media types may be transmitted to the policy control function based on negotiation of a service level agreement (SLA) with the policy control function.

In some examples, the core network element corresponds to a policy control function, and the transmitting, to the core network element, the QoS requirement information includes (i) directly transmitting, to the policy control function, the QoS requirement information; (ii) transmitting, to a network exposure function, the QoS requirement information, the network exposure function is configured to forward the QoS requirement information to the policy control function; or (iii) incorporating transmission of the QoS requirement information into a negotiation process of a service level agreement with the policy control function.

In some embodiments, the categorization information of the plurality of media types may be transmitted to the core network element in a similar manner. In some examples, the categorization information of the plurality of media types may be directly transmitted to the policy control function. Alternatively, the categorization information of the plurality of media types may be transmitted to the network exposure function, and then forwarded by the network exposure function to the policy control function. Alternatively, the categorization information of the plurality of media types may be transmitted to the policy control function based on negotiation of the service level agreement with the policy control function.

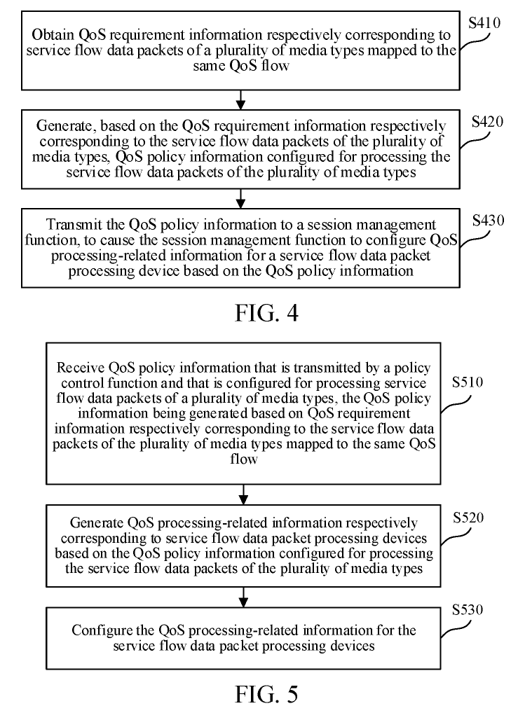

The technical solutions in one or more embodiments of this disclosure are described in terms of the application function. Implementation details of the technical solutions in one or more embodiments of this disclosure are further described below in terms of the policy control function (PCF) with reference to FIG. 4.

FIG. 4 is a flowchart of a QoS processing method according to an embodiment of this disclosure. The QoS processing method may be performed by a policy control function, or may be performed by another network element. As shown in FIG. 4, the QoS processing method includes at least S410 to S430, which are described in detail below.

S410: Obtain QoS requirement information respectively corresponding to service flow data packets of a plurality of media types mapped to the same QoS flow. For example, QoS requirement information of a multimedia service is obtained, data packets of the multimedia service being categorized into a plurality of media types and mapped to a QoS flow, and the QoS requirement information indicating respective QoS settings for the plurality of media types. In some examples, categorization information is obtained, where the categorization information indicates an association relationship between each of the data packet of the multimedia service and a corresponding one of the plurality of media types.

In some embodiments, a process of obtaining the QoS requirement information respectively corresponding to the service flow data packets of the plurality of media types mapped to the same QoS flow may be: receiving the QoS requirement information that respectively corresponds to the service flow data packets of the plurality of media types mapped to the same QoS flow and that is transmitted by an AF or another network element.

In some embodiments, in addition to obtaining the QoS requirement information respectively corresponding to the service flow data packets of the plurality of media types mapped to the same QoS flow, the policy control function may further obtain categorization information of the plurality of media types, to consider the categorization information when generating QoS policy information configured for processing the service flow data packets of the plurality of media types. This helps a service flow data packet processing device (for example, a UE, a base station, a UPF) detect and differentiate between service flow data packets of different media types based on a QoS-related policy or rule.

For related descriptions of the QoS requirement information and the categorization information of different media types, reference may be made to the technical solutions in the foregoing embodiments, and details are not described herein again.

S420: Generate, based on the QoS requirement information respectively corresponding to the service flow data packets of the plurality of media types, the QoS policy information configured for processing the service flow data packets of the plurality of media types. For example, based on the categorization information and the QoS requirement information, QoS policy information is generated by processing circuitry, where the QoS policy information indicates QoS policies for transmission of the data packets of the multimedia service in a communication system.

In some examples, the QoS policy information includes at least one of first indication of whether to map the data packets of the multimedia service to different QoS flows, second indication of whether to map the data packets of the multimedia service to the QoS flow, or the categorization information.

In some embodiments, the QoS policy information configured for processing the service flow data packets of the plurality of media types may include whether to map the service flow data packets of the plurality of media types to different QoS flows. For example, the service flow data packets of the plurality of media types may include a service flow data packet of an audio type, a service flow data packet of a video type, a service flow data packet of a haptic type, and the like. Therefore, the QoS policy information configured for processing the service flow data packets of the plurality of media types may include whether to map the service flow data packets of different media types to different QoS flows, that is, service flow data packets of various media types each uses a separate QoS flow. Certainly, the QoS policy information configured for processing the service flow data packets of the plurality of media types may directly include indication information configured for indicating that the service flow data packets of different media types are mapped to the different QoS flows, or include indication information configured for indicating that the service flow data packets of different media types are not mapped to the different QoS flows (for example, the service flow data packets of different media types are mapped to the same QoS flow).

In some embodiments, the QoS policy information configured for processing the service flow data packets of the plurality of media types may include whether to map the service flow data packets of different media types to the same QoS flow, that is, the service flow data packets of different media types use the same QoS flow. Certainly, the QoS policy information configured for processing the service flow data packets of the plurality of media types may directly include indication information configured for indicating that the service flow data packets of different media types are mapped to the same QoS flow.

In some embodiments, the QoS policy information configured for processing the service flow data packets of the plurality of media types may include the categorization information of the plurality of media types. For example, importance information of a service data packet set may be configured for indicating importance of the service flow data packets of different media types, so that the service flow data packets of different media types may be indicated by using the importance information of the service data packet set. Alternatively, the service flow data packets of different media types may be indicated in a media encapsulation manner. For example, in the foregoing embodiments, encapsulation is performed by using a QUIC protocol, an RTP protocol, a WebRTC protocol, a protocol stack of WebTransport, and the like, to differentiate between the service flow data packets of different media types.

In some embodiments, the QoS policy information configured for processing the service flow data packets of the plurality of media types may alternatively include a combination of two or more types of the foregoing information.

In this disclosure, the service flow data packets of the plurality of media types may be transmitted by using a PDU set, or transmitted by using a per-packet form. For example, the service flow data packets of the plurality of media types may be all transmitted by using the PDU set, or may be all transmitted by using the per-packet form. Alternatively, service flow data packets of some media types may be transmitted by using the PDU set, and service flow data packets of the other media types may be transmitted by using the per-packet form.

S430: Transmit the QoS policy information to a session management function, to cause the session management function to configure QoS processing-related information for a service flow data packet processing device based on the QoS policy information. For example, the QoS policy information is transmitted to a network element in the communication system, the network element is configured to configure the communication system based on the QoS policy information.

In some embodiments, a process of transmitting the QoS policy information to the session management function by the policy control function may be that the policy control function performs interaction with the session management function by using a signaling procedure of session management policy association establishment (SM Policy Association Establishment), or performs interaction by using a signaling procedure of session management policy association modification (SM Policy Association Modification), and then the policy control function transmits related policy information to the session management function by using a session management policy context data information element (SM Policy Context Data IE).

In some embodiments, for a process in which the session management function configures QoS processing-related information for a service flow data packet processing device based on the QoS policy information, reference may be made to the following embodiment shown in FIG. 5.

FIG. 5 is a flowchart of a QoS processing method according to an embodiment of this disclosure. The QoS processing method may be performed by a session management function (SMF) network element, or may be performed by another network element. As shown in FIG. 5, the QoS processing method includes at least S510 to S530, which are described in detail below.

S510: Receive QoS policy information that is transmitted by a policy control function and that is configured for processing service flow data packets of a plurality of media types, the QoS policy information being generated based on QoS requirement information respectively corresponding to the service flow data packets of the plurality of media types mapped to the same QoS flow. For example, QoS policy information is received, where the QoS policy information indicates QoS policies for transmission of data packets of a multimedia service, the data packets of the multimedia service being categorized into a plurality of media types and mapped to a QoS flow, the QoS policy information being generated based on categorization information and QoS requirement information of the multimedia service, and the categorization information indicating an association relationship between each of the data packet of the multimedia service and a corresponding one of the plurality of media types and the QoS requirement information indicating respective QoS settings for the plurality of media types.

The policy control function may further consider the categorization information of the plurality of media types when generating the QoS policy information. In some examples, the policy control function may generate the QoS policy information based on the QoS requirement information respectively corresponding to the service flow data packets of the plurality of media types mapped to the same QoS flow and the categorization information of the plurality of media types. In some embodiments, for related descriptions of the QoS requirement information and the categorization information of different media types, reference may be made to the technical solutions in the foregoing embodiments, and details are not described herein again.

S520: Generate QoS processing-related information respectively corresponding to service flow data packet processing devices based on the QoS policy information configured for processing the service flow data packets of the plurality of media types. For example, QoS processing-related information is generated by processing circuitry based on the QoS policy information.

In some embodiments, the service flow data packet processing devices may include a user plane function, a base station device, and a user equipment. The following describes that the session management function generates QoS processing-related information respectively corresponding to the user plane function, the base station device, and the user equipment.

In some embodiments, the session management function may generate, based on the QoS policy information configured for processing the service flow data packets of the plurality of media types, a service data flow (SDF) template corresponding to the user plane function configured to process the service flow data packets.

In some embodiments, the service data flow template may include the categorization information of the plurality of media types. The categorization information of the plurality of media types may be indicated by using importance information of a service data packet set. Alternatively, the service flow data packets of different media types may be indicated in a media encapsulation manner. For example, in the foregoing embodiments, encapsulation is performed by using the QUIC protocol, the RTP protocol, the WebRTC protocol, the WebTransport protocol stack, and the like, to differentiate between the service flow data packets of different media types.

In some embodiments, the service data flow template may include indication information configured for indicating that the service flow data packets of the plurality of media types are mapped to the same QoS flow.

In some embodiments, the service data flow template may include QoS parameter information respectively corresponding to the service flow data packets of the plurality of media types, so that even if the service flow data packets of the plurality of media types are mapped to the same QoS flow, QoS processing on the service flow data packets of different media types may be implemented based on the QoS parameter information corresponding to the service flow data packets of different media types.

In some embodiments, the service data flow template may include two or all of the categorization information of the plurality of media types, the indication information configured for indicating that the service flow data packets of the plurality of media types are mapped to the same QoS flow, and the QoS parameter information respectively corresponding to the service flow data packets of the plurality of media types.

In some embodiments, the session management function may generate, based on the QoS policy information configured for processing the service flow data packets of the plurality of media types, QoS profiles corresponding to the base station device processing the service flow data packets.

In some embodiments, the QoS profiles include the categorization information of the plurality of media types. The categorization information of the plurality of media types may be indicated by using the importance information of the service data packet set. Alternatively, the service flow data packets of different media types may be indicated in the media encapsulation manner. For example, in the foregoing embodiments, encapsulation is performed by using the QUIC protocol, the RTP protocol, the WebRTC protocol, the WebTransport protocol stack, and the like, to differentiate between the service flow data packets of different media types.

In some embodiments, when the base station device does not support processing the service flow data packets of the plurality of media types having different QoS requirements in the same QoS flow, the QoS profiles may indicate the base station device to process the service flow data packets of the plurality of media types by using different QoS flows. In at least one aspect, the indicating that the base station device processes the service flow data packets of the plurality of media types by using different QoS flows may be indicating that the base station device maps the service flow data packets of different media types to the different QoS flows.

In some embodiments, there is a correlation between the service flow data packets of the plurality of media types. For example, the service flow data packets of the plurality of media types may be included in a multimedia service. For example, a cloud gaming service may include a service flow data packet of an audio type and a service flow data packet of a video type that are correlated, or may include a service flow data packet of a haptic type, or the like. For another example, the service flow data packets of the plurality of media types may be included in a plurality of different multimedia services. For example, a cloud gaming service and a VR service are integrated to form a cloud gaming service having a virtual reality feeling. Therefore, the service flow data packets of the plurality of media types are associated. Therefore, when the QoS profiles indicate the base station device to process the service flow data packets of the plurality of media types by using different QoS flows, the QoS profiles may further indicate a correlation between the different QoS flows, so that associated processing can be applied to the associated service flow data packets by using indication information of the correlation. For example, synchronization between the service flow data packets of different media types (for example, synchronization between the service flow data packet of the audio type and the service flow data packet of the video type) can be implemented by means of control.

In some embodiments, if the QoS profiles indicate the base station device to process the service flow data packets of the plurality of media types by using different QoS flows, the QoS profiles may further include maintaining synchronization between service flow data packets corresponding to the different QoS flows by using a PDU set delay budget or a packet delay budget. The PDU set delay budget is applicable to synchronization between service flow data packets transmitted by using a PDU set. The packet delay budget is applicable to synchronization between service flow data packets transmitted by using a data packet.

In some embodiments, the QoS profiles may include the QoS parameter information respectively corresponding to the service flow data packets of the plurality of media types, so that even if the service flow data packets of the plurality of media types are mapped to the same QoS flow, QoS processing on the service flow data packets of different media types may be implemented based on the QoS parameter information corresponding to the service flow data packets of different media types.

In some embodiments, the QoS profiles may alternatively include a combination of two or more types of the foregoing information.

In some embodiments, the session management function may generate, based on the QoS policy information configured for processing the service flow data packets of the plurality of media types, QoS rule information (QoS rules) corresponding to the user equipment configured to process the service flow data packets.

In some embodiments, the QoS rule information may include the categorization information of the plurality of media types. The categorization information of the plurality of media types may be indicated by using the importance information of the service data packet set. Alternatively, the service flow data packets of different media types may be indicated in the media encapsulation manner. For example, in the foregoing embodiments, encapsulation is performed by using the QUIC protocol, the RTP protocol, the WebRTC protocol, the WebTransport protocol stack, and the like, to differentiate between the service flow data packets of different media types.

In some embodiments, the QoS rule information may include the indication information configured for indicating that the service flow data packets of the plurality of media types are mapped to the same QoS flow.

In some embodiments, the QoS rule information may include the QoS parameter information respectively corresponding to the service flow data packets of the plurality of media types, so that even if the service flow data packets of the plurality of media types are mapped to the same QoS flow, QoS processing on the service flow data packets of different media types may be implemented based on the QoS parameter information corresponding to the service flow data packets of different media types.

In some embodiments, the QoS rule information may include two or all of the categorization information of the plurality of media types, the indication information configured for indicating that the service flow data packets of the plurality of media types are mapped to the same QoS flow, and the QoS parameter information respectively corresponding to the service flow data packets of the plurality of media types.

S530: Configure the QoS processing-related information for the service flow data packet processing devices. In some examples, the QoS processing-related information is transmitted to a network element in a communication system configured to process transmission of the data packets in communication system based on the QoS processing-related information.

In some examples, the QoS processing-related information corresponds to a service data flow template that includes the categorization information, indication information indicating that the data packets are mapped to the QoS flow, or QoS parameter information corresponding to the plurality of media types. In some examples, the network element corresponds to a base station device, and the QoS processing-related information corresponds to QoS profiles that include the categorization information, QoS parameter information respectively corresponding to the plurality of media types, or when the base station device does not support processing the data packets having different QoS requirements in the same QoS flow, first indication information that indicates that the base station device is configured to process the data packets based on different QoS flows, and indicates a correlation between the different QoS flows. In some examples, when the QoS profiles include the first indication information that indicates that the base station device is configured to process the data packets based on the different QoS flows, the QoS profiles further include second indication information that indicates maintaining synchronization between portions of the data packets corresponding to the different QoS flows based on a PDU set delay budget or a packet delay budget.

In some embodiments, a process of configuring the QoS processing-related information for the service flow data packet processing devices may include: transmitting the service data flow template to the user plane function, transmitting the QoS profiles to the base station device, and transmitting the QoS rule information to the user equipment.

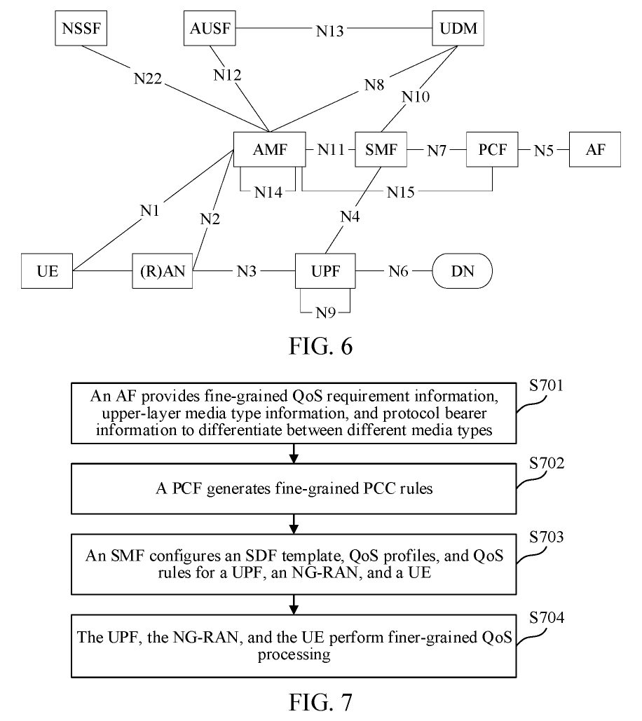

In at least one aspect, a 5G system is used as an example. FIG. 6 shows an architecture of key network elements in a 5G network defined by a 3rd generation partnership project (3GPP) organization. An access and mobility management function (AMF), an SMF, a UPF, a PCF, a network slice selection function (NSSF), an authentication server function (AUSF), a unified data management (UDM), and the like are core network elements of the 5G network. A UE may be a 5G terminal such as a mobile phone or a tablet computer. A (Radio) Access Network) ((R)AN) may be a 5G base station. A DN is a data network, that is, a service server accessed by the UE.

The AMF is responsible for termination of an N2 interface of a control plane of the base station, and implementation of encoding and decoding of a next generation application protocol (NGAP) based on a stream control transmission protocol (SCTP). The base station and the AMF transmit the application layer NGAP protocol by using the SCTP transport layer protocol, and carry non-access stratum (NAS) signaling data of the UE in the NGAP. The AMF is also responsible for termination of an N1 interface of the UE, and implementation of encryption and integrity protection of the NAS, and responsible for functions such as UE access authentication, authorization management, registration, connection, reachability, and mobility management, and responsible for transparent transmission of a session management message between the UE and the SMF.

In addition, the (R)AN interacts with the UPF through an N3 interface. The UPFs may interact with each other through an N9 interface. The UPF interacts with the SMF through an N4 interface. The UPF interacts with the DN through an N6 interface. The SMF interacts with the AMF through an N11 interface. The SMF interacts with the PCF through an N7 interface. The SMF interacts with the UDM through an N10 interface. The PCF interacts with an AF through an N5 interface. The AMFs may interact with each other through an N14 interface. The AMF interacts with the PCF through an N15 interface. The AMF interacts with the UDM through an N8 interface. The AMF interacts with the NSSF through an N22 interface. The AMF interacts with the AUSF through an N12 interface. The AUSF interacts with the UDM through an N13 interface.

Based on the architecture of the system shown in FIG. 6, the session management function may transmit the service data flow template to the user plane function through the N4 interface, transmit the QoS profiles to the base station device through the AMF, and transmit the QoS rule information to the user equipment through an AMF + NAS connection.

In view of the above, in the technical solutions of this disclosure, for an application layer service flow of a PDU set that may include different media types, a flow differentiation manner of a finer granularity than that of a five-tuple may be used, so that one QoS flow may be shared during transmission in a network. In this case, fine-grained identification and processing need to be performed on service flow data packets of different media types that shares one QoS flow, to meet QoS requirements of the service flow data packets of different media types.

In at least one aspect, as shown in FIG. 7, a QoS processing method according to an embodiment of this disclosure includes the following operations.

S701: An AF provides fine-grained QoS requirement information, upper-layer media type information, and protocol bearer information to differentiate between different media types.

In some embodiments, if a multimedia service flow includes different media types (for example, audio, video, haptic, or another media type), these media types may activate or not activate a PDU set mechanism, that is, may choose whether to perform data transmission by using a PDU set. In addition, service flow data packets of these different media types may have different QoS requirements and different upper-layer protocol encapsulation manners.

A QoS requirement provided for a media type which does not activate the PDU set mechanism may include a QoS parameter, for example, a PER or a PDB, for a data packet. A QoS requirement provided for a media type which activates the PDU set mechanism may include a QoS parameter, for example, a PSDB, a PSER, an MDBV, or a PDV, for the PDU set.

In some embodiments, the QoS requirement provided for a media type which activates the PDU set mechanism may further include the QoS parameter for the data packet. In this case, the QoS requirement for the data packet in a related standard protocol is reused, that is, the QoS parameter for the PDU set is added to the QoS requirement. Certainly, a brand new QoS requirement for the PDU set may alternatively be used to include QoS parameter information for the PDU set.

In some embodiments, if an upper-layer protocol of the service flow data packets uses a QUIC protocol, for example, an RTP over QUIC, the service flow data packets of different media types may be differentiated by using different QUIC connection IDs, or may be differentiated by using different stream IDs, or may be differentiated by using different QUIC connection IDs and different stream IDs.

In some embodiments, if the upper-layer protocol of the service flow data packets uses an RTP protocol, the service flow data packets of different media types may be differentiated by using different dynamic RTP protocol types (that is, payload types). For example, 96 represents a video frame, and 97 represents an audio frame.

In some embodiments, if the upper-layer protocol of the service flow data packets uses a WebRTC protocol, the service flow data packets of different media types may be differentiated by setting different transmission options or by setting different data type identifiers in an RTC peer connection.

In some embodiments, if the service flow data packets are encapsulated by using a WebTransport protocol stack, the service flow data packets of different media types may be differentiated by using one or more of different transport layer protocols, different port numbers, different load types, and different data channels.

The AF may form auxiliary information based on the upper-layer protocol encapsulation manners used by the service flow data packets of different media types, to provide the auxiliary information to a 5GS, and associate the auxiliary information with the QoS requirements of the service flow data packets of different media types, to support finer-grained QoS processing of the service flow data packets.

In some embodiments, a QoS requirement and policy control and charging (PCC) policy guidance information that are provided by the AF for a service flow data packet (for example, the PDU set) are not a PCC rule, and therefore may be described from a perspective of a service requirement without providing all parameters of the PCC rule. For example, different parameter values or parameter ranges may be provided for the QoS parameter (for example, one or more of the PSDB, the PSER, the MDBV, and the PDV) of the PDU set.

In some embodiments, to reduce an amount of information exchanged between the AF and a 5G core (5GC), the AF and the 5GC may alternatively negotiate an SLA to represent the QoS requirement information of the service flow data packets of different media types. In this case, the SLA may include the QoS requirement information of the service flow data packets of different media types.

In another embodiment of this disclosure, the AF may not provide the upper-layer media type information and the protocol bearer information to differentiate between the different media types, but another network element device differentiates between the different media types by detecting characteristics (for example, a frame rate, a resolution, and included data types) of service flow data packets of various media types. Alternatively, the service flow data packets of different media types may be differentiated between network element devices in a predetermined manner.

S702: A PCF generates fine-grained PCC rules.

In some embodiments, the AF transmits the upper-layer protocol encapsulation manner used by the service flow data packets of different media types and the QoS requirements of the service flow data packets of different media types to the PCF, or through an NEF to the PCF, or notifies the PCF by negotiating the SLA. In this way, the PCF may generate, based on subscription information of a user or the SLA with the AF, PCC rules required for finer-grained QoS processing, and the PCC rules include, but are not limited to, the following information:

whether to map the service flow data packets of different media types to different QoS flows; whether to differentiate between the service flow data packets of different media types by using PDU set importance (PSI); whether to indicate the service flow data packets of different media types by using information with a higher granularity than that of the PSI, for example, different media layer encapsulation information; and if the service flow data packets of different media types are mapped to the same QoS flow, configured PCC rules being supportive of corresponding finer-grained QoS processing by the UPF, the NG-RAN, and the UE.

In some embodiments, the PCF needs to transmit a part of the generated PCC rules that is required for an SMF to the SMF. In this way, the SMF may generate QoS processing-related information respectively corresponding to different devices (for example, the UPF, the NG-RAN, and the UE) based on information transmitted by the PCF.

In some embodiments, the QoS processing-related information generated by the SMF for the UPF may be an SDF template including a fine-grained identification and detection manner of the service flow data packets of different media types, which includes, but is not limited to (it is assumed that the UPF has an identification and processing capability within a five-tuple) the following manners.

If the upper-layer protocol of the service flow data packets uses the QUIC protocol, for example, the RTP over QUIC, the service flow data packets of different media types may be differentiated by using different QUIC connection IDs, or may be differentiated by using different stream IDs, or may be differentiated by using different QUIC connection IDs and different stream IDs.

If the upper-layer protocol of the service flow data packets uses the RTP protocol, the service flow data packets of different media types may be differentiated by using different dynamic RTP protocol types (that is, payload types). For example, 96 represents the video frame, and 97 represents the audio frame.

If the upper-layer protocol of the service flow data packets uses the WebRTC protocol, the service flow data packets of different media types may be differentiated by setting different transmission options or by setting different data type identifiers in the RTC peer connection.

If the upper-layer protocol of the service flow data packets uses a WebTransport protocol, the service flow data packets of different media types may be differentiated by using one or more of different transport layer protocols, different port numbers, different load types, and different data channels.

In some embodiments, the SDF template generated by the SMF for the UPF may further include a QoS flow mapping rule, that is, the service flow data packets (a downlink data packet is indicated for the UPF) of different media types are mapped to the same QoS flow, and differentiated and detected in the foregoing manner.

In some embodiments, the QoS processing-related information generated by the SMF for the NG-RAN includes QoS profiles that are on the NG-RAN and that support fine-grained QoS processing, and may alternatively include the following content: If the NG-RAN does not support fine-grained QoS processing, the NG-RAN may still use QoS processing of a QoS flow granularity, but the QoS profiles may include correlation information between a plurality of QoS flows. In this case, synchronization of data in different QoS flows may be guaranteed by using the PSDB of the PDU set or the PDB of a per-packet.

In some embodiments, the QoS processing-related information generated by the SMF for the UE may be QoS rule information, which includes the fine-grained identification and detection manner of the service flow data packets of different media types (in at least one aspect, as described in the foregoing embodiment), and may further include the QoS flow mapping rule, that is, the service flow data packets (an uplink data packet is indicated for the UE) of different media types are mapped to the same QoS flow, and differentiated and detected in the foregoing manner.

S703. An SMF configures an SDF template, QoS profiles, and QoS rule information for a UPF, an NG-RAN, and a UE.

In some embodiments, the SMF configures the SDF template for the UPF through an N4 interface. The SDF template includes finer-grained detection on the service flow data packets of different media types, the QoS rule information, and the like.

In addition, the SMF configures the QoS profiles for the NG-RAN through the AMF, to support finer-grained detection on the service flow data packets of different media types; and the SMF configures finer-grained detection on the service flow data packets of different media types, the QoS rule information, and the like for the UE through an AMF + NAS connection.

S704: The UPF, the NG-RAN, and the UE perform finer-grained QoS processing.

In some embodiments, when the UPF transmits the downlink data packet to the UE, if the service flow data packets of the plurality of media types need to be mapped to the same QoS flow and have different QoS requirements, the UPF may differentiate between the service flow data packets of the plurality of media types in different upper-layer protocol encapsulation manners, to apply the respective QoS requirements to the service flow data packets of various media types. When the UE transmits the uplink data packet to the UPF, if the service flow data packets of the plurality of media types need to be mapped to the same QoS flow and have different QoS requirements, the UE may differentiate between the service flow data packets of the plurality of media types in different upper-layer protocol encapsulation manners, to apply the respective QoS requirements to the service flow data packets of various media types. When the NG-RAN transits the service flow data packets between the UE and the UPF, the NG-RAN may also implement finer-grained detection on the service flow data packets of different media types, to apply the respective QoS requirements to the service flow data packets of different media types.

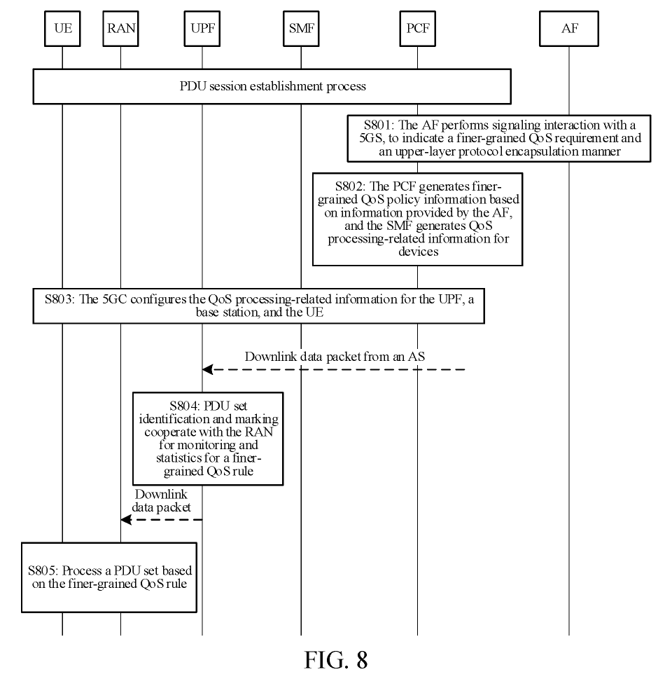

The following describes the technical solutions of one or more embodiments of this disclosure by using an example with reference to FIG. 8. The following operations are included.

S801: After establishment of a PDU session is completed, an AF performs signaling interaction with a 5G system (5GS), to indicate a finer-grained QoS requirement and an upper-layer protocol encapsulation manner.

S802: A PCF generates finer-grained QoS policy information based on information provided by the AF, and an SMF generates QoS processing-related information for devices.

In some embodiments, the QoS processing-related information for the devices generated by the SMF includes an SDF template for a UPF, QoS profiles for an NG-RAN, and QoS rule information for a UE.

S803: The 5GC configures the QoS processing-related information for the UPF, a base station, and the UE.

In some embodiments, the SMF configures the SDF template for the UPF through an N4 interface, the SMF configures the QoS profiles for the NG-RAN through an AMF, and the SMF configures the QoS rule information for the UE through an AMF + NAS connection.

S804: PDU set identification and marking cooperate with an RAN for monitoring and statistics for a finer-grained QoS rule.

S805: Process a PDU set based on the finer-grained QoS rule.

For example, if it is detected that one or more of parameters such as a PSDB, a PSER, and a PDV of a service flow data packet of a media type in the same QoS flow exceed the QoS requirement, notification information is transmitted to a core network, to trigger a PDU session modification procedure or another procedure.

The technical solutions in this disclosure provides a finer-grained service flow processing solution. When service flow data packets of different media types share the QoS flow, fine-grained identification and processing may be performed on the service flow data packets of different media types, to meet QoS requirements of the service flow data packets of different media types, so as to improve resource utilization when the 5GS carries a service, for example, an XRM, that includes service flow data packets of a plurality of media types, to better support an immersive XRM service.

The following describes apparatus embodiments of this disclosure, which may be configured for performing the QoS processing method in the foregoing embodiments of this disclosure. For details not disclosed in the apparatus embodiments of this disclosure, reference may be made to the foregoing QoS processing method embodiments of this disclosure.

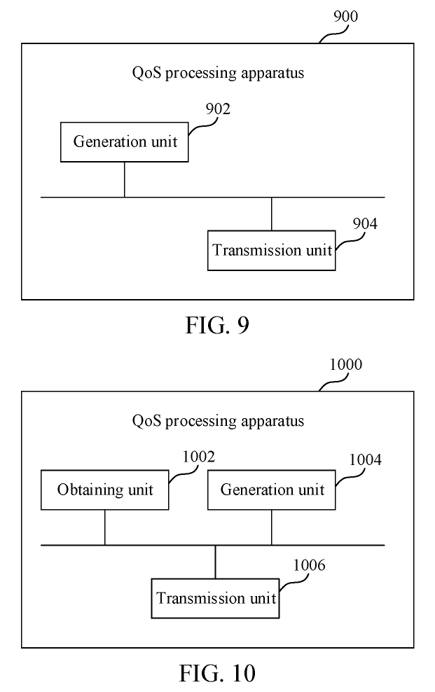

FIG. 9 is a block diagram of a QoS processing apparatus according to an embodiment of this disclosure. The QoS processing apparatus may be used in an AF or another network element.

As shown in FIG. 9, a QoS processing apparatus 900 according to an embodiment of this disclosure includes a generation unit 902 and a transmission unit 904.

The generation unit 902 is configured to generate QoS requirement information respectively corresponding to service flow data packets of a plurality of media types mapped to the same QoS flow; and the transmission unit 904 is configured to provide, to a core network element, the QoS requirement information respectively corresponding to the service flow data packets of the plurality of media types, to cause the core network element to generate QoS policy information corresponding to the plurality of media types based on the QoS requirement information.

In some embodiments of this disclosure, based on the foregoing solutions, the transmission unit 904 is further configured to provide categorization information of the plurality of media types to the core network element, to cause the core network element to generate the QoS policy information corresponding to the plurality of media types based on the categorization information and the QoS requirement information.

In some embodiments of this disclosure, based on the foregoing solutions, the service flow data packets of the plurality of media types are encapsulated in different media encapsulation manners. The transmission unit 904 is configured to provide the media encapsulation manners respectively corresponding to the service flow data packets of the plurality of media types to the core network element.

In some embodiments of this disclosure, based on the foregoing solutions, the service flow data packets are encapsulated in at least one of the following media encapsulation manners:

performing encapsulation by using a quick user datagram protocol Internet connections (QUIC) protocol, service flow data packets of different media types using different QUIC connection identifiers and/or different QUIC stream identifiers;

performing encapsulation by using a real-time transport protocol (RTP), the service flow data packets of different media types using different payload types;

performing differentiated encapsulation by using a protocol stack of a web real-time communication (WebRTC) protocol; or

performing differentiated encapsulation by using a protocol stack of WebTransport.

In some embodiments of this disclosure, based on the foregoing solutions, the service flow data packets of the plurality of media types are respectively transmitted by using a service data packet set. A QoS parameter in the QoS requirement information corresponding to the service flow data packets of the plurality of media type includes at least one of the following parameters: a protocol data unit PDU set delay budget, a PDU set error rate, a maximum data burst volume, or a data packet delay variation.

In some embodiments of this disclosure, based on the foregoing solutions, the transmission unit 904 is configured to: directly transmit, to a policy control function, the QoS requirement information respectively corresponding to the service flow data packets of the plurality of media types; or

transmit, to a network exposure function, the QoS requirement information respectively corresponding to the service flow data packets of the plurality of media types, to cause the network exposure function to forward the QoS requirement information to a policy control function; or

negotiate a service level agreement with a policy control function, to provide, to the policy control function, the QoS requirement information respectively corresponding to the service flow data packets of the plurality of media types.

FIG. 10 is a block diagram of a QoS processing apparatus according to an embodiment of this disclosure. The QoS processing apparatus may be used in a policy control function or another network element.

As shown in FIG. 10, a QoS processing apparatus 1000 according to an embodiment of this disclosure includes an obtaining unit 1002, a generation unit 1004, and a transmission unit 1006.

The obtaining unit 1002 is configured to obtain QoS requirement information respectively corresponding to service flow data packets of a plurality of media types mapped to the same QoS flow; the generation unit 1004 is configured to generate, based on the QoS requirement information respectively corresponding to the service flow data packets of the plurality of media types, QoS policy information configured for processing the service flow data packets of the plurality of media types; and the transmission unit 1006 is configured to transmit the QoS policy information to a session management function, to cause the session management function to configure QoS processing-related information for a service flow data packet processing device based on the QoS policy information.

In some embodiments of this disclosure, based on the foregoing solutions, the obtaining unit 1002 is further configured to obtain categorization information of the plurality of media types; and the generation unit 1004 is configured to generate, based on the categorization information and the QoS requirement information respectively corresponding to the service flow data packets of the plurality of media types, QoS policy information configured for processing the service flow data packets of the plurality of media types.

In some embodiments of this disclosure, based on the foregoing solutions, the QoS policy information configured for processing the service flow data packets of the plurality of media types includes at least one of the following information:

whether to map the service flow data packets of the plurality of media types to different QoS flows;

whether to map the service flow data packets of the plurality of media types to the same QoS flow; or

the categorization information of the plurality of media types.

In some embodiments of this disclosure, based on the foregoing solutions, the categorization information of the plurality of media types is indicated in at least one of the following manners: service flow data packets of different media types are indicated by using importance information of a service data packet set; or the service flow data packets of different media types are indicated in a media encapsulation manner.

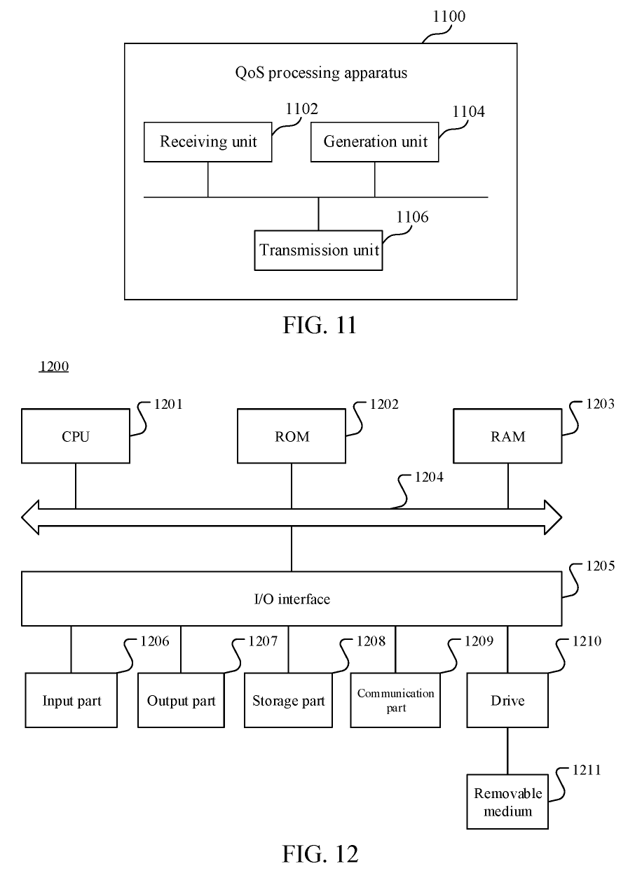

FIG. 11 is a block diagram of a QoS processing apparatus according to an embodiment of this disclosure. The QoS processing apparatus may be used in a session management function or another network element.

As shown in FIG. 11, a QoS processing apparatus 1100 according to an embodiment of this disclosure includes a receiving unit 1102, a generation unit 1104, and a transmission unit 1106.

The receiving unit 1102 is configured to receive QoS policy information that is sent by a policy control function and that is configured for processing service flow data packets of a plurality of media types, the QoS policy information being generated based on QoS requirement information respectively corresponding to the service flow data packets of the plurality of media types mapped to the same QoS flow; the generation unit 1104 is configured to generate QoS processing-related information respectively corresponding to service flow data packet processing devices based on the QoS policy information; and the transmission unit 1106 is configured to configure the QoS processing-related information for the service flow data packet processing devices.

In some embodiments of this disclosure, based on the foregoing solutions, the generation unit 1104 is configured to generate, based on the policy information, a service data flow template corresponding to a user plane function configured to process the service flow data packets, the service data flow template including at least one of the following information: categorization information of the plurality of media types, indication information configured for indicating that the service flow data packets of the plurality of media types are mapped to the same QoS flow; or QoS parameter information respectively corresponding to the service flow data packets of the plurality of media types.

In some embodiments of this disclosure, based on the foregoing solutions, the generation unit 1104 is configured to generate, based on the QoS policy information, QoS profiles corresponding to a base station device processing the service flow data packets, the QoS profiles including at least one of the following information:

categorization information of the plurality of media types;

QoS parameter information respectively corresponding to the service flow data packets of the plurality of media types; or

if the base station device does not support processing the service flow data packets of the plurality of media types having different QoS requirements in the same QoS flow, indicating the base station device to process the service flow data packets of the plurality of media types by using different QoS flows, and indicating a correlation between the different QoS flows.

In some embodiments of this disclosure, based on the foregoing solutions, if the QoS profiles indicate the base station device to process the service flow data packets of the plurality of media types by using different QoS flows, the QoS profiles further include maintaining synchronization between the service flow data packets corresponding to the different QoS flows by using a PDU set delay budget or a packet delay budget.

In some embodiments of this disclosure, based on the foregoing solutions, the generation unit 1104 is configured to generate, based on the QoS policy information, QoS rule information corresponding to a user equipment configured to process the service flow data packets, the QoS rule information including at least one of the following information:

categorization information of the plurality of media types;

indication information configured for indicating that the service flow data packets of the plurality of media types are mapped to the same QoS flow; or

QoS parameter information respectively corresponding to the service flow data packets of the plurality of media types.

FIG. 12 is a schematic structural diagram of a computer system adapted to implement an electronic device according to an embodiment of this disclosure. The electronic device may be the function, the policy control function, or the session management function in the foregoing embodiments.

A computer system 1200 of the electronic device shown in FIG. 12 is an example, and does not constitute any limitation on functions and use ranges of one or more embodiments of this disclosure.

As shown in FIG. 12, the computer system 1200 may include processing circuitry (e.g., a central processing unit (CPU) 1201), which may perform various suitable actions and processing based on a program stored in a read-only memory (ROM) 1202 or a program loaded from a storage part 1208 into a random access memory (RAM) 1203, for example, perform the method in the foregoing embodiments. The RAM 1203 further has various programs and data required for system operation stored therein. The CPU 1201, the ROM 1202, and the RAM 1203 are connected to each other by a bus 1204. An input/output (I/O) interface 1205 is further connected to the bus 1204.

The following components may be connected to the I/O interface 1205: an input part 1206 including a keyboard, a mouse, or the like; an output part 1207 including a cathode ray tube (CRT), a liquid crystal display (LCD), a speaker, or the like; the storage part 1208 including a hard disk or the like; and a communication part 1209 including a network interface card such as a local area network (LAN) card or a modem. The communication part 1209 performs communication processing through a network, for example, the Internet. A drive 1210 is further connected to the I/O interface 1205 based on a requirement. A removable medium 1211 such as a magnetic disk, an optical disc, a magneto-optical disk, or a semiconductor memory is installed on the drive 1210 based on a requirement, so that a computer program read from the removable medium 1211 is installed into the storage part 1208 based on a requirement.

In some embodiments, the processes described in the foregoing with reference to the flowcharts may be implemented as a computer software program. For example, this embodiment of this disclosure includes a computer program product, which includes a computer program carried on a computer-readable medium, the computer program being configured to perform the method shown in the flowcharts. In one or more embodiments, the computer program may be uploaded and installed from the network through the communication part 1209, and/or be installed from the removable medium 1211 (which may be a non-transitory computer-readable storage medium). When the computer program is executed by the central processing unit (CPU) 1201, the various functions limited in the system of this disclosure are performed.

The computer-readable medium shown in one or more embodiments of this disclosure may be a non-transitory computer-readable storage medium or any combination thereof. In some embodiments, the non-transitory computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any appropriate combination thereof. In this disclosure, a non-transitory computer-readable storage medium may be a tangible medium that includes or stores the computer a program. The program may be used by or used in combination with an instruction execution system, apparatus, or device.

The flowcharts and block diagrams in the accompanying drawings illustrate possible system architectures, functions, and operations that may be implemented by a system, a method, and a computer program product according to various embodiments of this disclosure. Each block in a flowchart or a block diagram may represent a module, a program segment, or a part of code. The module, the program segment, or the part of code includes one or more executable instructions for implementing specified logic functions. In some implementations used as substitutes, functions annotated in boxes may alternatively occur in a sequence different from that annotated in the accompanying drawings. For example, two blocks shown in succession may be actually performed basically in parallel, and sometimes may be performed in a reverse sequence, which is determined by an involved function. Each block in a flowchart or a block diagram and combinations of the blocks in the flowcharts or the block diagrams may be implemented by a dedicated hardware-based system that performs a specified function or operation, or may be implemented by a combination of dedicated hardware and a computer program.

A unit described in one or more embodiments of this disclosure may be implemented by software or by hardware, and may be alternatively disposed in a processor. Names of these units do not constitute a limitation on the units.

In another aspect, this disclosure further provides a non-transitory computer-readable storage medium. The non-transitory computer-readable storage medium may be included in the electronic device described in the foregoing embodiments, or may exist alone without being assembled into the electronic device. The non-transitory computer-readable storage medium may store one or more computer programs. When executed by the electronic device, the one or more computer programs cause the electronic device to implement the method according to the foregoing embodiments.

Although several modules or units of a device for performing actions are mentioned in the foregoing descriptions, such division is not compulsory. According to one or more embodiments of this disclosure, features and functions of two or more modules or units described above may be specified in one module or unit. On the contrary, features and functions of one module or unit described above may be further divided to be specified by a plurality of modules or units.

According to the descriptions of the foregoing implementations, a person skilled in the art may understand that the examples described herein may be implemented by means of software, or may be implemented by combining software and necessary hardware. Therefore, the technical solutions according to the examples of this disclosure may be implemented in a form of a software product. The software product may be stored in a non-volatile storage medium or a non-transitory computer-readable storage medium (which may be a CD-ROM, a USB flash drive, a removable hard disk, or the like) or on a network, and include several instructions for instructing an electronic device to perform the method according to the implementations of this disclosure.

For example, the electronic device may be the application function, and the application function may perform the QoS processing method shown in FIG. 3. For another example, the electronic device may be the policy control function, and the policy control function may perform the QoS processing method shown in FIG. 4. For another example, the electronic device may be the session management function, and the session management function network element may perform the QoS processing method shown in FIG. 5.

After considering the specification and practicing the implementations of the present disclosure, a person skilled in the art may conceive of other implementations of this disclosure. This disclosure is intended to cover any variations, uses, or adaptive changes of this disclosure. These variations, uses, or adaptive changes follow the general principles of this disclosure are within the scope of this disclosure.

This disclosure is not limited to the structures described above and shown in the accompanying drawings, and various modifications and changes may be made without departing from the scope of this disclosure.

What is claimed is:

1. A quality of service (QoS) processing method, comprising:
generating, by processing circuitry, QoS requirement information of a multimedia service, data packets of the multimedia service being categorized into a plurality of media types and mapped to a QoS flow, and the QoS requirement information indicating respective QoS settings for the plurality of media types;
transmitting, to a core network element in a communication system, categorization information indicating an association relationship between each of the data packets of the multimedia service and a corresponding one of the plurality of media types; and
transmitting, to the core network element, the QoS requirement information, wherein
the core network element is configured to generate QoS policy information indicating QoS policies for transmission of the data packets of the multimedia service based on the categorization information and the QoS requirement information.

2. The method according to claim 1, wherein
the data packets of the multimedia service are encapsulated based on one of a plurality of candidate media encapsulation formats, and
the categorization information indicates the association relationship based on one or more of the plurality of candidate media encapsulation formats.

3. The method according to claim 2, wherein
the data packets of the multimedia service are encapsulated based on a quick user datagram protocol Internet connections (QUIC) protocol, and
the categorization information indicates that different media types are identifiable based on different QUIC connection identifiers or different QUIC stream identifiers of the data packets.

4. The method according to claim 2, wherein
the data packets of the multimedia service are encapsulated based on a real-time transport protocol (RTP), and
the categorization information indicates that different media types are identifiable based on different payload type identifiers of the data packets.

5. The method according to claim 2, wherein
the data packets of the multimedia service are encapsulated based on a protocol stack of a web real-time communication (WebRTC) protocol, and
the categorization information indicates that different media types are encapsulated based on different WebRTC encapsulation approaches.

6. The method according to claim 2, wherein
the data packets of the multimedia service are encapsulated based on a protocol stack of web transport (WebTransport), and
the categorization information indicates that different media types are encapsulated based on different WebTransport encapsulation approaches.

7. The method according to claim 1, wherein
the data packets of the multimedia service are transmitted over a protocol data unit (PDU) set, and
the QoS requirement information includes at least one of a PDU set delay budget, a PDU set error rate, a maximum data burst volume, or a data packet delay variation.

8. The method according to claim 1, wherein
the core network element corresponds to a policy control function, and
the transmitting, to the core network element, the QoS requirement information includes:
directly transmitting, to the policy control function, the QoS requirement information;
transmitting, to a network exposure function, the QoS requirement information, the network exposure function is configured to forward the QoS requirement information to the policy control function; or
incorporating transmission of the QoS requirement information into a negotiation process of a service level agreement with the policy control function.

9. A quality of service (QoS) processing method, comprising:
obtaining QoS requirement information of a multimedia service, data packets of the multimedia service being categorized into a plurality of media types and mapped to a QoS flow, and the QoS requirement information indicating respective QoS settings for the plurality of media types;
obtaining categorization information indicating an association relationship between each of the data packet of the multimedia service and a corresponding one of the plurality of media types;
generating, by processing circuitry based on the categorization information and the QoS requirement information, QoS policy information indicating QoS policies for transmission of the data packets of the multimedia service in a communication system; and
transmitting the QoS policy information to a network element in the communication system, the network element being configured to configure the communication system based on the QoS policy information.

10. The method according to claim 9, wherein the QoS policy information includes at least one of:
first indication of whether to map the data packets of the multimedia service to different QoS flows,
second indication of whether to map the data packets of the multimedia service to the QoS flow, or
the categorization information.

11. The method according to claim 9, wherein
the data packets of the multimedia service are encapsulated based on one of a plurality of candidate media encapsulation formats, and
the categorization information indicates the association relationship based on one or more of the plurality of candidate media encapsulation formats.

12. The method according to claim 11, wherein
the data packets of the multimedia service are encapsulated based on a quick user datagram protocol Internet connections (QUIC) protocol, and
the categorization information indicates that different media types are identifiable based on different QUIC connection identifiers or different QUIC stream identifiers of the data packets.

13. The method according to claim 11, wherein
the data packets of the multimedia service are encapsulated based on a real-time transport protocol (RTP), and
the categorization information indicates that different media types are identifiable based on different payload type identifiers of the data packets.

14. The method according to claim 11, wherein
the data packets of the multimedia service are encapsulated based on a protocol stack of a web real-time communication (WebRTC) protocol, and
the categorization information indicates that different media types are encapsulated based on different WebRTC encapsulation approaches.

15. The method according to claim 11, wherein
the data packets of the multimedia service are encapsulated based on a protocol stack of web transport (WebTransport), and
the categorization information indicates that different media types are encapsulated based on different WebTransport encapsulation approaches.

16. The method according to claim 9, wherein
the data packets of the multimedia service are transmitted over a protocol data unit (PDU) set, and
the QoS requirement information includes at least one of a PDU set delay budget, a PDU set error rate, a maximum data burst volume, or a data packet delay variation.

17. A quality of service (QoS) processing method, comprising:
receiving QoS policy information indicating QoS policies for transmission of data packets of a multimedia service, the data packets of the multimedia service being categorized into a plurality of media types and mapped to a QoS flow, the QoS policy information being generated based on categorization information and QoS requirement information of the multimedia service, and the categorization information indicating an association relationship between each of the data packet of the multimedia service and a corresponding one of the plurality of media types and the QoS requirement information indicating respective QoS settings for the plurality of media types;
generating, by processing circuitry, QoS processing-related information based on the QoS policy information; and
transmitting the QoS processing-related information to a network element in a communication system configured to process transmission of the data packets in communication system based on the QoS processing-related information.

18. The method according to claim 17, wherein
the network element corresponds to a user plane function or a user equipment, and
the QoS processing-related information corresponds to a service data flow template that includes:
the categorization information,
indication information indicating that the data packets are mapped to the QoS flow, or
QoS parameter information corresponding to the plurality of media types.

19. The method according to claim 17, wherein
the network element corresponds to a base station device, and
the QoS processing-related information
corresponds to QoS profiles that include:
the categorization information,
QoS parameter information respectively corresponding to the plurality of media types, or
when the base station device does not support processing the data packets having different QoS requirements in the same QoS flow, first indication information indicating that the base station device is configured to process the data packets based on different QoS flows, and indicating a correlation between the different QoS flows.

20. The method according to claim 19, wherein
when the QoS profiles include the first indication information indicating that the base station device is configured to process the data packets based on the different QoS flows, the QoS profiles further include second indication information indicating maintaining synchronization between portions of the data packets corresponding to the different QoS flows based on a PDU set delay budget or a packet delay budget.
